(19) United States
(12) Patent Application Publication
(10) Pub. No.: US 2003/0214187 A1
(43) Pub. Date: Nov. 20, 2003

(54) Drive track for snowmobile or similar recreational vehicle

(75) Inventor: Denis Courtemanche, Richmond (CA)

Correspondence Address: DARBY & DARBY P.C., P. O. BOX 5257, NEW YORK, NY, 10150-5257, US

(73) Assignee: CAMOPLAST INC., Sherbrooke (CA)

(21) Appl. No.: 10/352,333

(22) Filed: Jan. 27, 2003

(30) Foreign Application Priority Data
May 16, 2002 (CA) 2,386,697

(51) Int. Cl. B62D 55/24

(52) U.S. Cl. 305/167

(57) ABSTRACT

The drive track of a snowmobile or similar recreational vehicle consists of an endless body formed of a molded rubber base having, embedded therein, a series of laterally spaced longitudinally extending steel reinforcements strands, reach strand being formed of a twisted arrangement of steel filaments. The strands limit the elongation of the body due to heat generated as a result of the high rotational speeds of the track when driven.

### FIELD OF THE INVENTION

The present invention pertains to a drive track and, more particularly, to a track for snowmobiles or other similar recreational vehicles having an improved construction to limit the elongation of the track when the latter is driven at high rotational speeds.

### BACKGROUND OF THE INVENTION

Drive tracks of the type described consist of an endless body having a ground engaging outer side and suspension supporting inner side, the body defining a central portion and a pair of opposite lateral portions. These portions are interconnected by a plurality of longitudinally spaced suspension bearing portions.

The endless body is formed of a molded rubber base having, embedded therein one or more layers of reinforcing fabric, a series of laterally spaced cords of polyester and a series of reinforcing bars that extend crosswise of the track in the central and opposite lateral portions thereof. In some cases, these tracks display a series of studs which extend through the thickness of the track to provide additional gripping to the outer side of the track, especially on icy surfaces.

These drive tracks, especially on snowmobiles, are driven at very high speeds and it has been observed that heat is generated as a result of these high speeds causes the track to elongate, which elongation cannot be limited by the cords of polyester embedded in the rubber base. As a consequence, a certain thickness of rubber must be maintained in order to provide adequate resistance to this elongation. Also, in cases where studs are used, it has been observed that the studs are often outwardly projected, leaving holes in the tracks.

### STATEMENT OF THE INVENTION

The present invention is concerned with an improved drive track for a snowmobile or similar recreational vehicles (such as all-terrain vehicles) which overcomes the above problems; this is achieved by embedding in the rubber base, a steel reinforcement to reduce the elongation of the endless body of the track when driven.

The present invention therefore relates to a snowmobile drive track, which comprises:

an endless body having a ground engaging outer side and a suspension supporting inner side; the body defining a central portion and opposite lateral portions interconnected by a plurality of longitudinally spaced suspension bearing portions; the body being formed of a molded rubber base having, embedded in each of the central and opposite lateral portions, a series of laterally spaced longitudinally extending steel reinforcement strands, each strand being formed of a twist arrangement of steel filaments; the strands limiting the elongation of the body due to heat generated as a result of high rotational speeds of the track when driven.

In one preferred form of the invention, the strands are brass coated for adequate adhesion to the rubber base.

Other objects and further scope of applicability of the present invention will become apparent from the detailed description given hereinafter. It should be understood, however, that this detailed description, while indicating preferred embodiments of the invention, is given by way of illustration only, since various changes and modifications within the spirit and scope of the invention will become apparent to those skilled in the art.

### BRIEF DESCRIPTION OF THE DRAWINGS

FIG. 1 is a perspective view of a portion of a snowmobile track made in accordance with the present invention;

FIG. 2 is a top plan view showing part of the ground engaging outer side of the track;

FIG. 3 is a cross-sectional view taken along lines 3-3 of FIG. 2;

FIG. 4 is a cross-sectional view taken along lines 4-4 of FIG. 3; and

FIG. 5 is a graph showing the elongation variation between polyester and steel.

### DESCRIPTION OF PREFERRED EMBODIMENTS

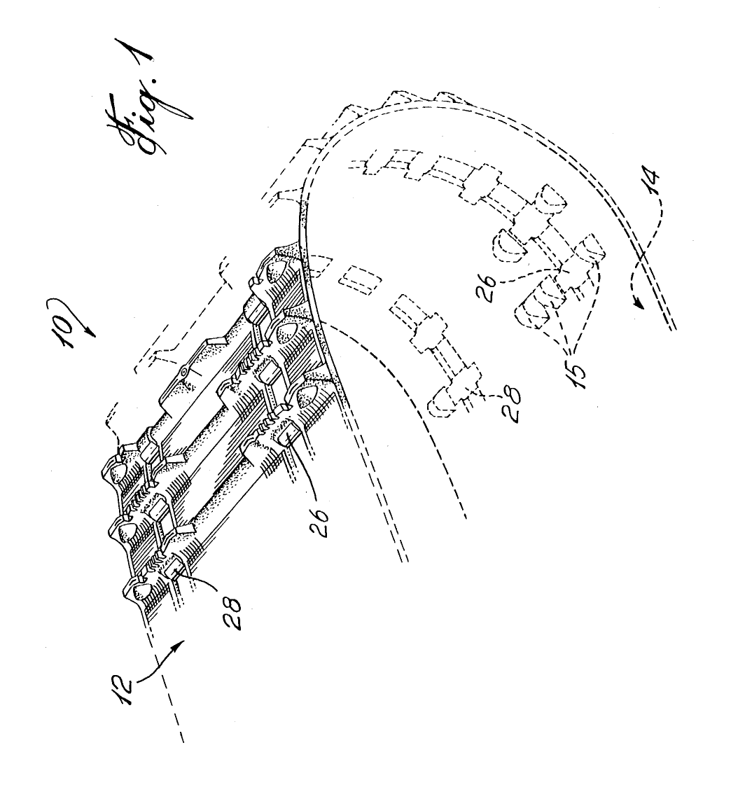

Referring to FIG. 1, there is shown, in part, an endless drive track, generally denoted 10, for propelling, in the present case, a snowmobile over snow, ice or other similar ground structure. The mounting of this track to a snowmobile is well known and needs not be detailed. Similarly, the mounting of an endless drive track on an all-terrain vehicle is known and needs not be detailed. The track has a ground engaging outer side 12 and an inner side 14 that receives and supports, on the lower run thereof, a suspension which may consist of a wheel assembly or a slide rail assembly, both of which are also well known in the art.

Conventionally, the track rotates by means of a motor driven sprocket unit at the forward end of the vehicle and idle drive wheels are mounted at the aft end of the vehicle to support the rear end of the track. Sprockets engage a series of lugs 15 integrally formed with the inner surface of the track.

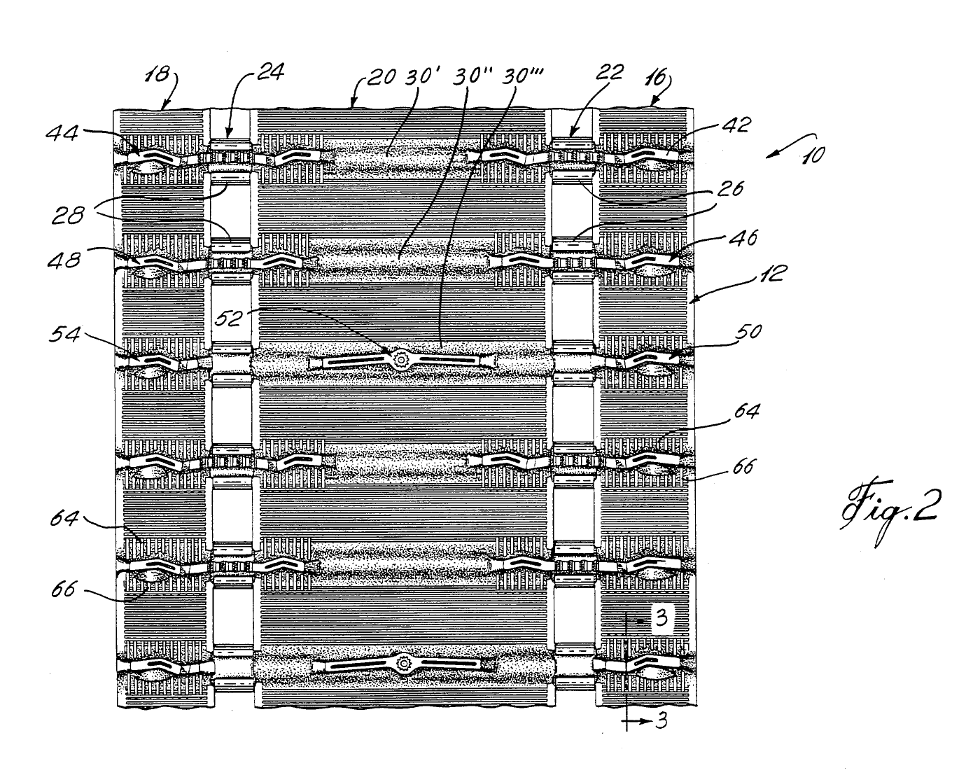

As illustrated in FIG. 2, the track defines a pair of opposite lateral portions 16 and 18 and a central portion 20. These portions are interconnected by a plurality of longitudinally spaced suspension bearing portions 22 and 24 which are partially covered by metallic clips 26, 28. These clips may have various forms; however, they are structured so that, in the case of a slide rail suspension system, the rails that support the chassis of the snowmobile slide on the rear faces of the clips 26 and 28.

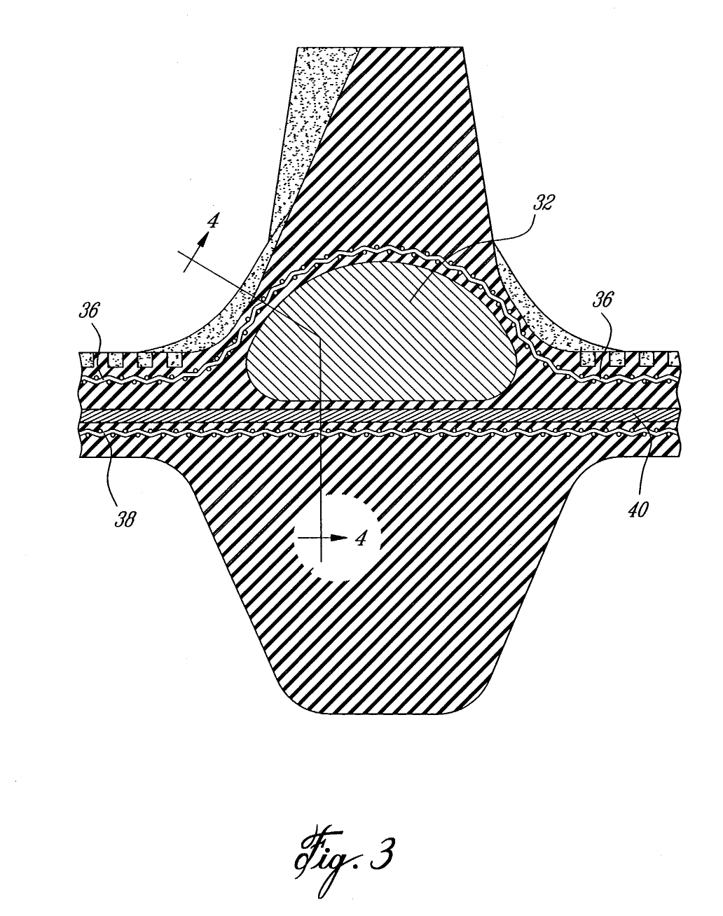

The snowmobile track 10 also defines a plurality of crossbar receiving areas 30., 30., 30. that extend through the central, lateral and suspension bearing portions. Referring to FIG. 3, each of these crossbar receiving areas incorporates a crossbar 32 which preferably consists of a rod, made of composite material, having a shape as illustrated in FIG. 3. The track is formed of a molded rubber base in which are embedded two layers 36 and 38 of reinforcing fabric extending longitudinally of the track.

The present invention is concerned with embedding in the snowmobile track as series of laterally spaced longitudinally extending steel reinforcement strands 40. In the embodiment illustrated, these strands extend between the layers of fabric 36 and 38 of reinforcing fabric while passing beneath the cross bars 32.

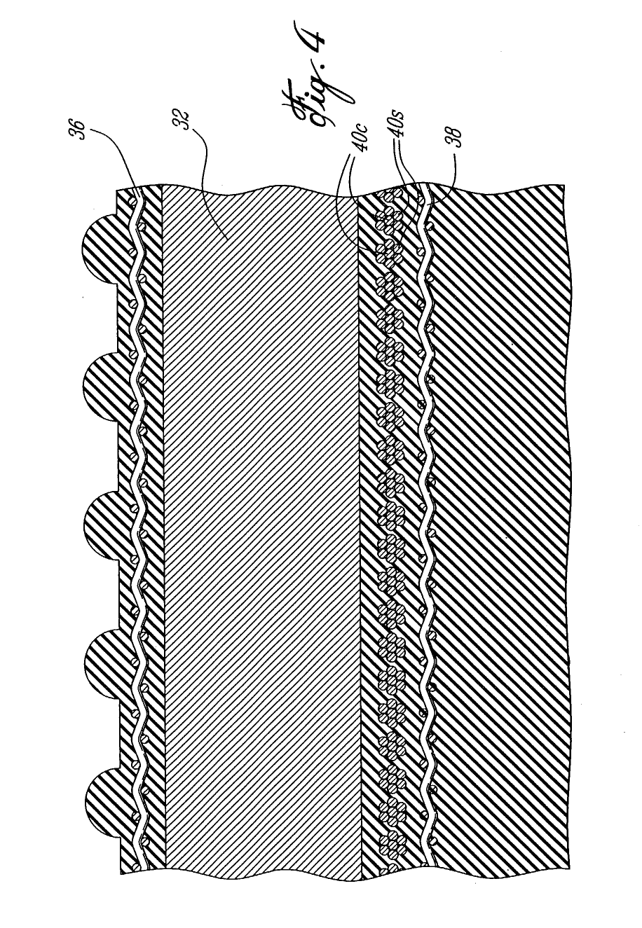

One embodiment of the strand arrangement is illustrated in FIG. 4 showing one central filament 40c surrounded by five filaments 40s. The diameter of the strand is about 0.55 mm.

In another embodiment of the invention, each strand is formed of three central filaments and nine filaments twisted therearound. The diameter of this strand is about 0.75 mm.

The lateral spacing of these strands relative to one another is between 10 strands per inch and 18 strands per inch.

It is also preferred that the strands be brass coated in order to provide adequate adhesion to the rubber base. Also, the rubber is preferably treated so as to have steel adhering properties.

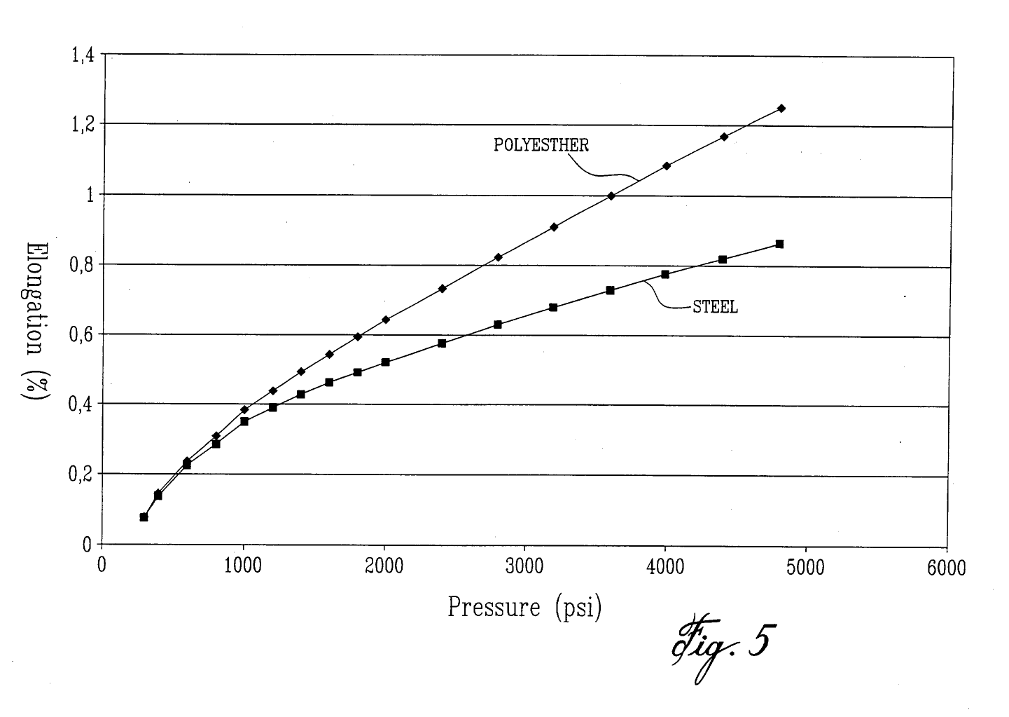

It has been found that, in addition to reduce the elongation of the track (as illustrated by the graph of FIG. 5), the presence of steel instead of polyester in the rubber has a cooling effect of the heated track when driven. It also enables to reduce the thickness of the track which thereby is lighter than conventional tracks.

Although the invention has been described above with respect to one specific form, it will be evident to a person skilled in the art that it may be modified and refined in various ways. It is therefore wished to have it understood that the present invention should not be limited in scope, except by the terms of the following claims.

1. A drive track for propelling a snowmobile or similar recreational vehicle comprising: an endless body having a ground engaging outer side and a suspension supporting inner side; said body defining a central portion and opposite lateral portions interconnected by a plurality of longitudinally spaced suspension bearing portions; said body being formed of a molded rubber base having, embedded in each of said central and opposite lateral portions, a series of laterally spaced longitudinally extending steel reinforcement strands, each strand being formed of a twisted arrangement of steel filaments; said strands limiting the elongation of said body due to heat generated as a result of high rotational speeds of said track when driven.

2. A drive track as defined in claim 1, wherein said strands are brass coated for adhesion to said rubber base.

3. A drive track as defined in claim 1, wherein each said strand is about 0.55 mm in diameter and consist of five filaments twisted over a central filament.

4. A drive track as defined in claim 1, wherein each said strand is about 0.75 mm in diameter and consist of nine filaments twisted over three central filaments.

5. A drive track as defined in claim 1, wherein said strands are laterally spaced from one another a distance having a value between 1/10 and 1/18 of an inch.

6. A drive track as defined in claim 1, wherein said rubber base consists of a rubber having steel adhering properties.
